(19) United States
(12) Patent Application Publication
(10) Pub. No.: US 2010/0162665 A1
(43) Pub. Date: Jul. 1, 2010

(54) Apparatus for manufacturing a bag pack

(75) Inventors: Tien Tjiu Tan, Kuala Lumpur (MY); Jack Randal Wilkerson, Umatilla, FL (US)

Correspondence Address: LAW OFFICE OF STEVEN R. OLSEN, PLLC, P.O. BOX 2092, INVERNESS, FL, 34451-2092, US

(73) Assignee: IPS INDUSTRIES, INC.

(21) Appl. No.: 12/319,067

(22) Filed: Dec. 31, 2008

(51) Int. Cl. B65B 43/26; B26F 1/14

(52) U.S. Cl. 53/459; 83/684

(57) ABSTRACT

In an embodiment of the invention, a bottom seal of a plastic bag is strengthened by welding together 8 layers of plastic film. In one respect, an embodiment of the invention provides an apparatus configured to weld together 8 layers of plastic film on a bottom edge of a folded bag, and then unfold the bag. The apparatus may also stack multiple unfolded bags into a bag pack.

### BACKGROUND

1. Field of the Invention

The invention relates generally to plastic bags, and more particularly, but without limitation, to an apparatus for manufacturing a bag pack.

2. Description of the Related Art

Plastic bags are used in a variety of applications, including bagging groceries and/or other items at a retail point of sale. A common plastic bag for such applications has a pair of carrying handles that extend from the top of the bag body on opposite sides of the bag opening. Such bags are often referred to as T-shirt or vest bags because the handles loosely resemble the short sleeves of a T-shirt or shoulder straps of a vest. T-shirt bags are typically manufactured and distributed in bag packs that are configured to cooperate with a standard retailer dispensing rack.

Plastic bags can be a significant overhead cost for a retailer. It would therefore be desirable to decrease the manufacturing cost of such bags. One way to reduce the cost of a plastic bag is to reduce the thickness of its walls, thereby reducing the plastic content. A problem with such an approach, however, is that thinner walls generally translate to decreased load strength. An apparatus for manufacturing thinner-walled bags without sacrificing load strength is needed. Preferably, the resulting bag packs would be configured such that individual bags can be fully supported by the dispensing rack while being filled with goods.

### SUMMARY OF THE INVENTION

Embodiments of the invention seek to overcome one or more of the shortcomings described above. In an embodiment of the invention, an apparatus is configured to weld together 8 layers of plastic film on a bottom edge of a folded bag, and then unfold the bag. The apparatus may also stack multiple unfolded bags into a bag pack.

An embodiment of the invention provides a bag manufacturing system. The bag manufacturing system can include: a conveyor system; and an unfolding module operationally coupled to the conveyor system, the unfolding module configured to at least partially unfold a folded bag to produce an unfolded bag, the folded bag having 8 layers, the unfolded bag having 4 layers.

Another embodiment of the invention provides a bag manufacturing die set. The bag manufacturing die set includes: an upper die having a first heater tip, a second heater tip, and a blade; and a lower die having a third heater tip, a fourth heater tip, and a plate; the first heater tip and the third heater tip configured to cooperate in a first contact weld operation, the second heater tip and the fourth heater tip configured to cooperate in a second contact weld operation, the blade and the plate configured to perform a cutting operation; the die set being configured such that the first contact weld operation, the second contact weld operation, and the cutting operation can be performed substantially simultaneously; the die set further including a separator, the separator operationally coupled to the first heater tip and the third heater tip, the separator configured such that it can be disposed between a fourth layer and a fifth layer of an 8-layer folded bag during the first contact weld operation.

### BRIEF DESCRIPTION OF THE DRAWINGS

The invention will be more fully understood from the detailed description below and the accompanying drawings, wherein:

FIG. 1 is a flow diagram of a bag manufacturing process, according to an embodiment of the invention;

FIG. 2 is a flow diagram of a cutting and welding process, according to an embodiment of the invention;

FIG. 3 is a flow diagram of an unfolding process, according to an embodiment of the invention;

FIG. 4 is a plan view of a formed plastic material, according to an embodiment of the invention;

FIG. 5 is a cross-sectional view of a tubular portion along plane A-A in FIG. 4, according to an embodiment of the invention;

FIG. 6 is a cross-sectional view of a gusset forming tool, according to an embodiment of the invention;

FIG. 7 is a cross-sectional view of a gusseted portion along plane B-B in FIG. 4, according to an embodiment of the invention;

FIG. 8 is a cross-sectional view of a folded portion along plane C-C in FIG. 4, according to an embodiment of the invention;

FIG. 9 is a plan view of a folded bag, according to an embodiment of the invention;

FIG. 10 is an elevation view of a die set, according to an embodiment of the invention;

FIG. 11 is a plan view of a gusseted portion, according to an embodiment of the invention;

FIG. 12 is an elevation view of a folded bag portion in alignment with the die set, according to an embodiment of the invention;

FIG. 13 is an elevation view of a folded bag portion in alignment with the die set, according to an embodiment of the invention;

FIG. 14 is a plan view of a folded bag portion, according to an embodiment of the invention;

FIG. 15 is a perspective view of a partially-unfolded bag, according to an embodiment of the invention;

FIG. 16 is a plan view of an unfolded and uncut bag, according to an embodiment of the invention;

FIG. 17 is a perspective view of a stack of unfolded and uncut bags, according to an embodiment of the invention;

FIG. 18 is a perspective view of a bag-forming apparatus, according to an embodiment of the invention;

FIG. 19 is a perspective view of a bag pack, according to an embodiment of the invention; and

FIG. 20 is a perspective view of an opened bag, according to an embodiment of the invention.

### DETAILED DESCRIPTION

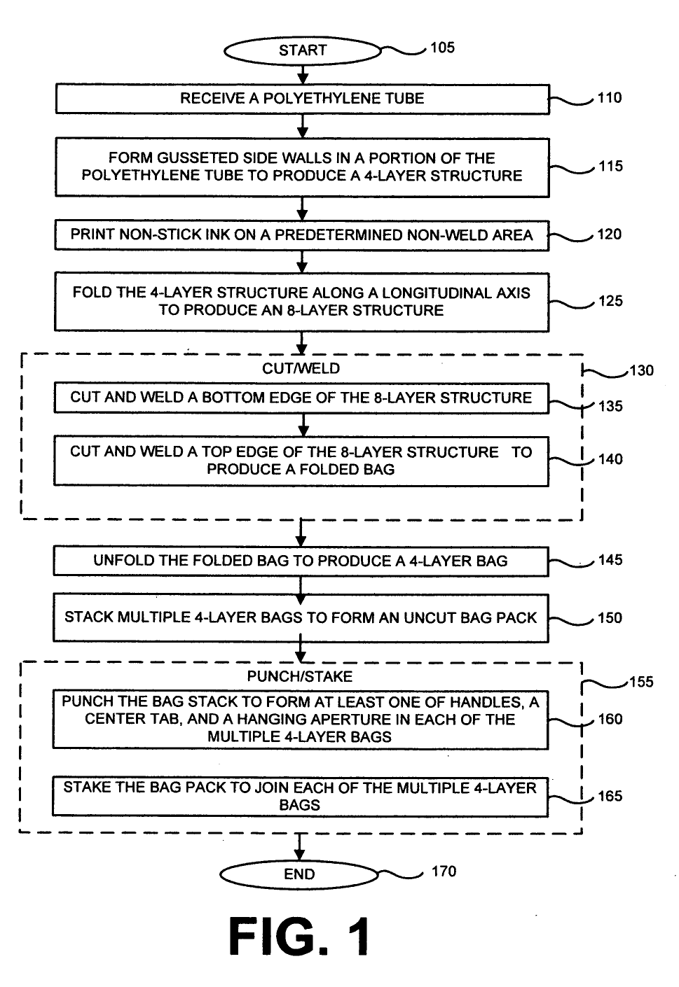

The invention will now be described more fully with reference to FIGS. 1-20, in which embodiments of the invention are shown. This invention may, however, be embodied in many different forms and should not be construed as limited to the embodiments set forth herein. In the drawings, reference designators may be duplicated for the same or similar features. The figures are not drawn to scale; some features are exaggerated for clarity.

FIG. 1 is a flow diagram of a bag manufacturing process, according to an embodiment of the invention. The illustrated process begins in step 105, and receives a polyethylene tube in step 110. Blow molding and other methods for forming plastic tubes with desired wall thicknesses and diameter are known in the art. In embodiments of the invention, the wall thickness of the tube received in step 110 is substantially uniform at approx. 9 to 10 um. Such a dimension is relatively thin compared to a film thickness of approx. 14 to 15 um that is more typical of conventional grocery-sized T-shirt style plastic bags.

The process forms gusseted side walls in the polyethylene tube in step 115. In embodiments of the invention, the gussets meet substantially in the center of the tube (as illustrated in FIG. 7). The plastic material is thus formed such that there are generally 4 plastic layers from front to back: a front layer, 2 gusset layers, and a back layer. Accordingly, the result of gusseting step 115 may alternatively be referred to herein as a gusseted portion, a 4-layered portion, a 4-layered structure, or with similar language.

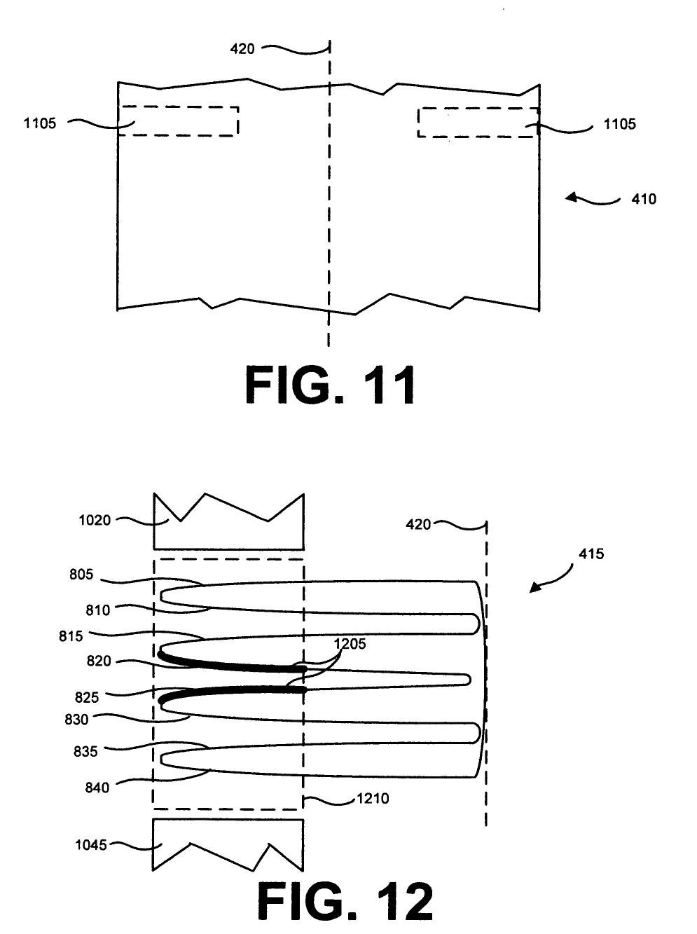

In step 120, the process prints a non-stick ink on a predetermined non-weld area. The non-stick ink applied in step 120 may be or include, for example, a mold-release agent such as silicone, paraffin, and/or a fluorocarbon. The purpose of the non-stick ink is to selectively prevent a plastic weld. Embodiments of printing step 120 are further described with reference to FIGS. 11 and 12.

The process then folds the 4-layered structure along a longitudinal axis to produce an 8-layered structure in step 125. Because of the folding step used, the resulting structure is also referred to herein as a folded portion. Embodiments of the folded portion are illustrated in FIGS. 8, 12 and 13, and are further described below.

Next, the process advances to cutting and welding step 130. In the illustrated embodiment, cutting and welding step 130 includes first cutting and welding a bottom edge of the 8-layer structure in step 135, and then cutting and welding a top edge of the 8-layer structure to produce a folded bag in step 140. A folded bag is distinguished from a folded portion in that the former is welded on at least one edge.

The cutting processes in steps 135 and 140 may be or include, for example, die cutting, laser cutting, water-jet cutting, or other cutting processes, according to design choice. The welding processes in steps 135 and 140 may be or include, for example, heat sealing, hot gas welding, contact welding, laser welding, solvent welding, or other suitable method. As used herein, contact welding is a process that joins two or more plastic components by pinching them together between heated tips.

Subsequent to step 130, the process unfolds the folded bag to produce a 4-layered bag in step 145. The 4-layered bag may also be referred to herein as an unfolded bag. The process then stacks multiple 4-layered bags to form an uncut bag pack in step 150. The result of step 150 is called an uncut bag pack because features such as handles and hanging apertures have not yet been formed.

The process then advances to punching/staking step 155. As illustrated in FIG. 1, step 155 may include performing steps 160 and 165, but not necessarily in any particular order. In the illustrated embodiment, step 160 includes punching (or die cutting) the bag pack to form at least one of handles, a center tab, and a hanging aperture in each of the multiple 4-layered bags. Step 165 may include staking the bag pack to at least temporarily join adjacent bags in the bag stack with an interference fit. Such staking facilitates loading bags at a dispensing rack because the back panel of a first bag in the bag pack is temporarily secured to the front panel of a second bag in the bag pack at the first bag is being loaded with goods. A friction pin resulting from staking step 165 typically includes a rounded head.

The process terminates in step 170.

One advantage of the process illustrated in FIG. 1 is that it produces bags with very strong 8-layer bottom welds. Another advantage is that the bags are unfolded prior to stacking. A bag pack with unfolded bags means that each handle of a T-shirt style bag can be supported on a separate hanger of a dispensing rack.

Variations to the process illustrated in FIG. 1 are possible. For example, in alternative embodiments, the receiving step 110 could include receiving a nylon tube or another plastic tube other than polyethylene. The gusseting step 115 could include forming less than full gussets (i.e., gussets that do not substantially meet in the center), so that the resulting structure is not a uniformly 4-layered structure. In alternative embodiments, the printing step 120 could be performed prior to the gusseting step 115. Moreover, in an embodiment where a separator is used (described with reference to FIG. 6), the printing step 120 can be eliminated. The sequence of cutting and welding in steps 135 and 140 could be reordered and recombined as appropriate. In embodiments of the invention that are described with reference to FIG. 16, a punching step may be added prior to, or during, stacking step 150 to form stacking alignment holes. The punching/staking step 155 could execute steps 160 and 165 in any sequence, or in parallel, according to design choice. Instead of, or in combination with staking step 165, the process could include a pinning step to provide a releasable bond between layers and bags in a bag pack. A pinning operation differs from staking step 165 in that the pinning geometry typically includes two orthogonal lines (e.g., an “x” shape) rather than a round head.

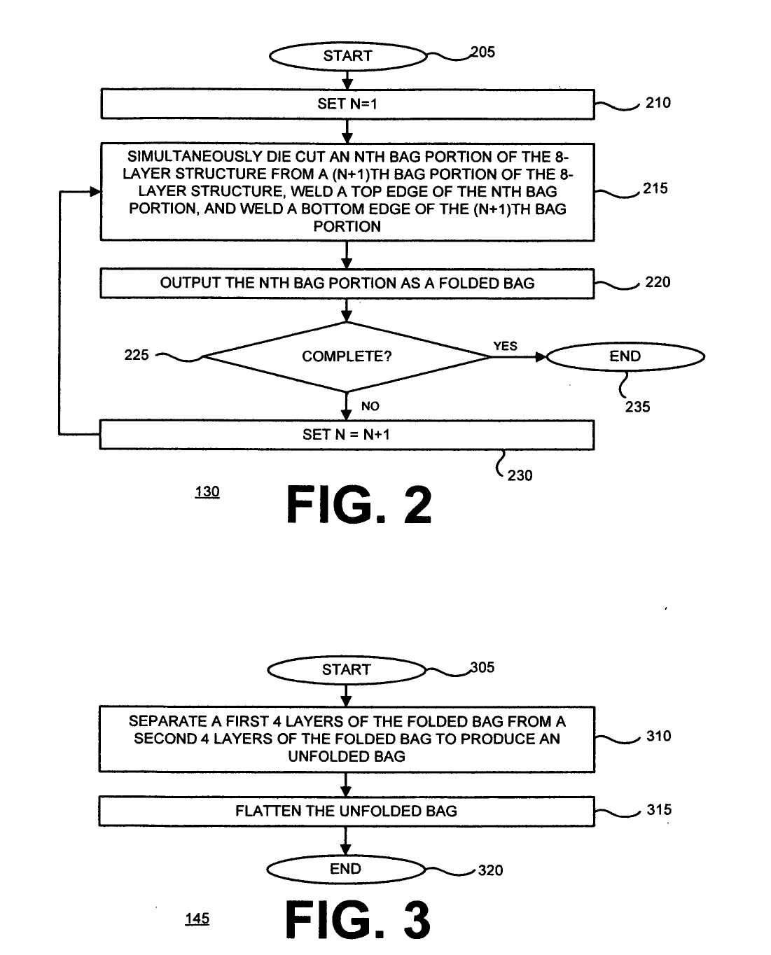

FIG. 2 is a flow diagram of a cutting and welding process, according to an embodiment of the invention. The illustrated process is an inline embodiment of the cutting/welding step 130. The process begins in step 205, and sets N equal to 1 in step 210. Then, in step 215, the process simultaneously die cuts an Nth bag portion of the 8-layer structure from a (N+1)th bag portion of the 8-layer structure, welds a top edge of the Nth bag portion, and welds a bottom edge of the (N+1)th bag portion. Next, the process outputs the top-welded Nth bag portion as a folded bag in step 220. The process then advances to conditional step 225 to determine whether the cutting and welding process 130 is complete. Where the result of conditional step 225 is not satisfied, the process advances to step 230 to set N equal to N+1. Subsequent to step 230, the process returns to step 215. The process thus performs step 215 twice for each fully-welded folded bag. Where the result of conditional step 225 is satisfied, the process terminates in step 235.

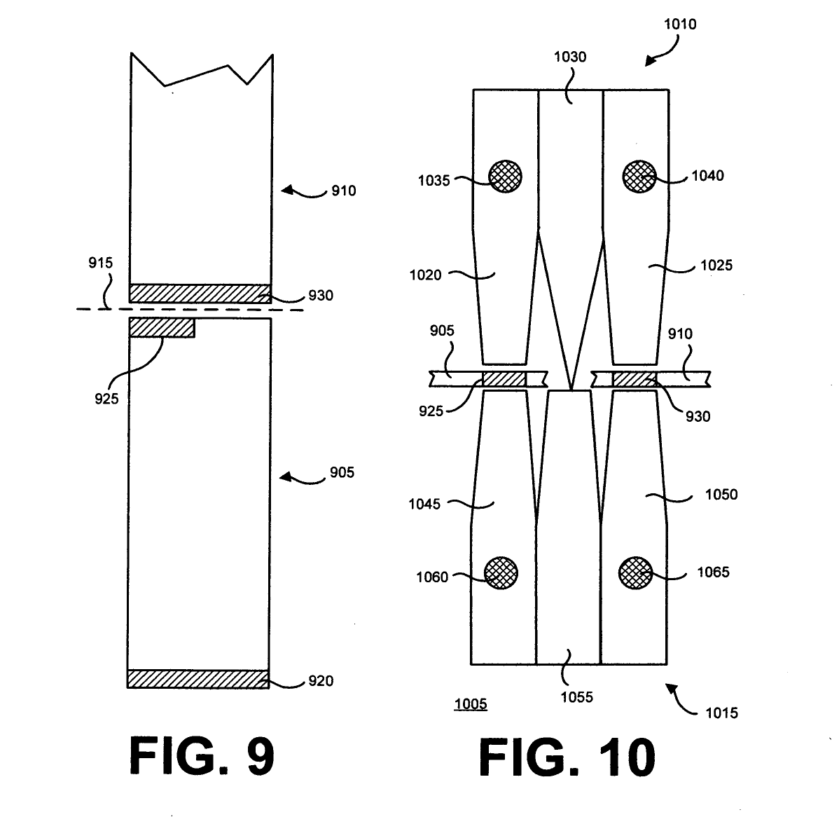

The process flow illustrated in FIG. 2 accommodates a high-speed in-line manufacturing process by simultaneously performing one separation cut and two welds. The process illustrated in FIG. 2 can be more fully understood with reference to FIGS. 9 and 10 below. Alternative processes that weld a single edge at a time can also be used.

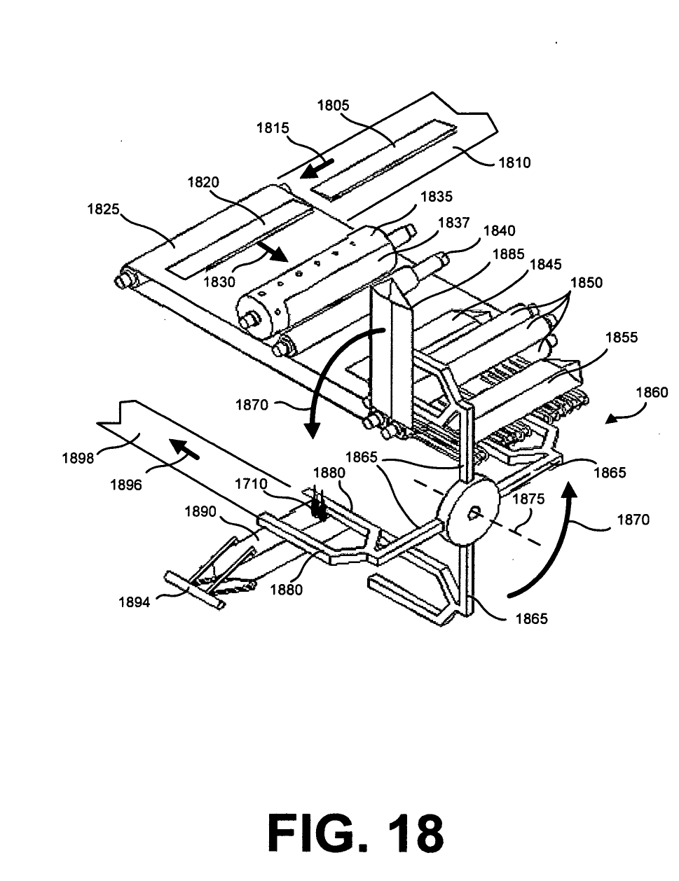

FIG. 3 is a flow diagram of an unfolding process, according to an embodiment of the invention. The illustrated process is an embodiment of unfolding step 145. The process in FIG. 3 begins in step 305. Next, the process separates a first 4 layers of the folded bag from a second 4 layers of the folded bag to produce an unfolded bag in step 310. Then, the process flattens the unfolded bag in step 315. The unfolding process terminates in step 320. Embodiments of unfolding step 145 are further described below with reference to FIGS. 15 and 18.

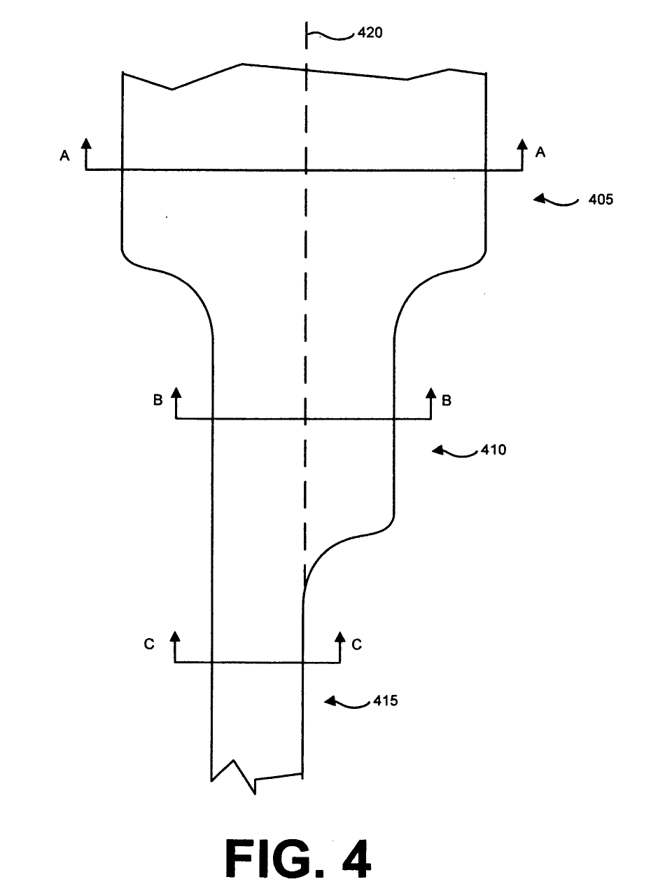

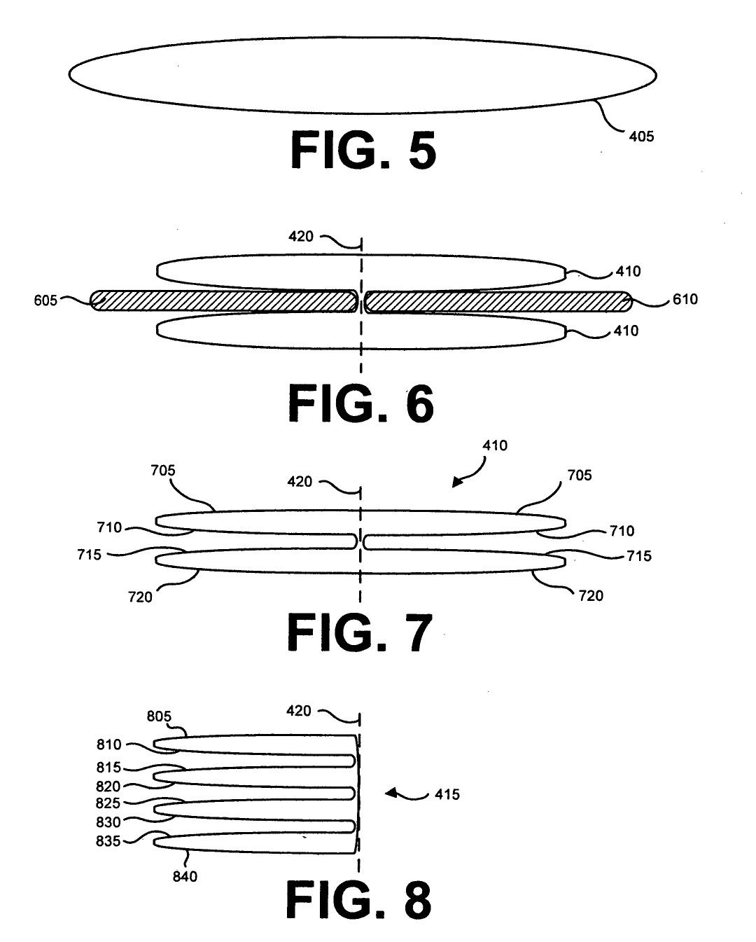

FIG. 4 is a plan view of a formed plastic material, according to an embodiment of the invention. FIG. 4 illustrates the progression of formed plastic film in a bag manufacturing process. In sequence, FIG. 4 shows a tubular portion 405, a gusseted or 4-layered portion 410, and a folded or 8-layered portion 415. The tubular portion 405 may be as received in step 110. The gusseted or 4-layered portion 410 may be as formed by step 115. The folded or 8-layered portion 415 may be as output from step 125. Cross-sectional views of these same features are provided in FIGS. 5, 7, and 8.

FIG. 5 is a cross-sectional view of the tubular portion 405 along plane A-A in FIG. 4, according to an embodiment of the invention. The tubular portion 405 may be, for example, several inches or several feet in diameter, according to application demands.

FIG. 6 is a cross-sectional view of a gusset forming tool, according to an embodiment of the invention; FIG. 7 is a cross-sectional view of the gusseted portion 410 along plane B-B in FIG. 4, according to an embodiment of the invention. As shown in FIG. 6, the tubular portion 405 may be deformed using gusset forming tools 605 and 610. In the illustrated embodiment, the gusseting tools 605 and 610 substantially meet along a center line 420 of the 4-layered portion 410. The gusseting tools 605 and 610 may be, for instance, constructed of wood or other thermal insulator. The resulting structure of the 4-layered portion 410 is shown in FIG. 7. As illustrated therein, except at the center line 420, the 4-layered portion 410 includes a first, second, third, and fourth layer 705, 710, 715, and 720, respectively. Layers 710 and 715 are the gusset layers.

FIG. 8 is a cross-sectional view of the folded portion 415 along plane C-C in FIG. 4, according to an embodiment of the invention. The 8-layered portion 415 is formed by folding the 4-layered portion 410 onto itself. The center line 420 is the fold line. The resulting 8-layered structure 415 includes first, second, third, fourth, fifth, sixth, seventh, and eighth layers 805, 810, 815, 820, 825, 830, 835, and 840, respectively.

FIG. 9 is a plan view of a folded bag, according to an embodiment of the invention. A first folded bag 905 is substantially rectangular and includes an 8-layered bottom weld 920 and a top weld 925. As described below, the top weld 925 may include two 4-layered welds. A second folded bag 910 includes an 8-layered bottom weld 930.

In an embodiment of the invention, the configuration illustrated in FIG. 9 is the result of two passes of cutting/welding step 130. For example, on a first pass of the cutting/welding step 130, the bottom weld 920 may be formed. On a second pass of the cutting/welding step 130, the process may separate the first folded bag 905 from the second folded bag 910 along a cut line 915 and also produce the top weld 925 and the bottom weld 930.

Variations to the configuration illustrated in FIG. 9 are possible. For example, in an alternative embodiment, the top weld 925 could extend across the entire top edge of the first folded bag 905.

FIG. 10 is an elevation view of a die set, according to an embodiment of the invention. The illustrated die set 1005 is configured to perform the cutting/welding step 130. The die set 1005 may include an upper die 1010 and a lower die 1015. The upper die 1010 may include heating tips 1020 and 1025, and a blade 1030. The heating tips 1020 and 1025 may include tubular heaters 1035 and 1040, respectively. The bottom die 1015 may include heater tips 1045 and 1050, and plate 1055. The heater tips 1045 and 1050 may include tubular heaters 1060 and 1065, respectively.

In operation, the tubular heaters 1035, 1040, 1060, and 1065 heat the corresponding heater tips 1020, 1025, 1045, and 1050. The heater tips 1020 and 1045 may cooperate to contact weld the 8-layer folded bag 905 at the top weld area 925. Likewise, the heater tips 1025 and 1050 cooperate to form a contact weld at the bottom weld 930 of the folded bag 910. Simultaneously, the blade 1030 may cooperate with the plate 1055 to separate the folded bag 905 from the folded bag 910.

Although not illustrated in FIG. 10, it should be appreciated that the geometries of the heater tips may vary according to the target weld areas. For instance, with reference to FIGS. 9 and 10, the heater tips 1025 and 1050 could be substantially longer in one dimension than heater tips 1020 and 1045, since the bottom weld 930 is longer than the top weld 925. In addition, instead of tubular heaters 1035, 1040, 1060, and 1065, cartridge heaters or other heat sources could be used to heat the heater tips 1020, 1025, 1045, and/or 1050.

FIG. 11 is a plan view of a gusseted portion 410, according to an embodiment of the invention. As illustrated therein, a gusseted or 4-layered portion 410 may include printing areas 1105. The printing areas 1105 may be associated with the printing step 120. The location of the printing areas 1105 may correspond to a future top weld area 925.

FIG. 12 is an elevation view of a folded portion 415 in alignment with the die set 1005, according to an embodiment of the invention. As shown therein, layers 820 and 825 of the 8-layered portion 415 include non-stick ink 1205. The location of the non-stick ink 1205 on layers 820 and 825 correspond to a top weld area 1210. The top weld area 1210 is a side view of top weld area 925.

During a contract weld operation, for example cutting/welding step 130, heater tips 1020 and 1045 draw toward each other, applying heat and pressure to each layer of the folded portion 415 at the weld area 1210. The non-stick ink 1205 prevents welding between layers 820 and 825. The result of the weld operation will thus be two 4-layered welds. A first 4-layered weld includes layers 805, 810, 815, and 820; a second 4-layered weld includes layers 825, 830, 835, and 840.

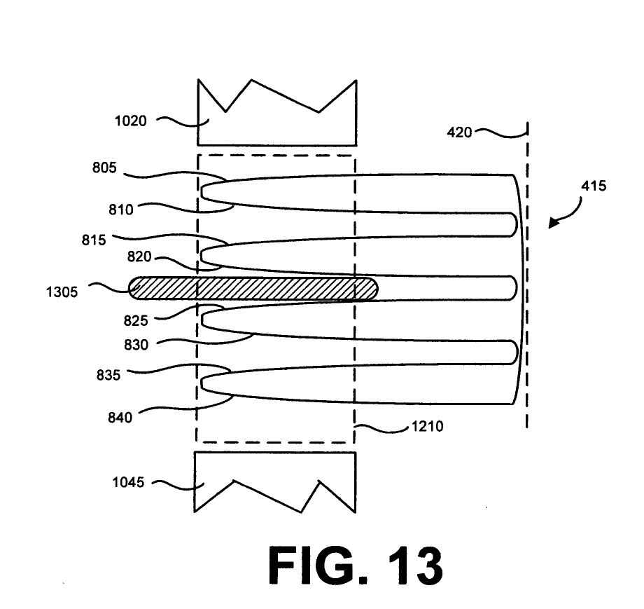

An alternative method may be used to prevent a weld between layers 820 and 825. FIG. 13 is an elevation view of a folded portion 415 in alignment with the die set 1005, according to an embodiment of the invention. A shown therein, a separator 1305 may be inserted between layers 820 and 825 during cutting/welding step 130. The separator 1305 provides a temporary physical barrier. The separator 1305 may be or include, for example, a metallic component having an anti-stick coating. For instance, the separator 1305 could be Teflon-coated steel. The separator 1305 can be considered part of the die set 1005 since at least two of the heater tips, for example heater tips 1020 and 1045, are configured to cooperate with the separator 1305.

During a contract weld operation, for example cutting/welding step 130, heater tips 1025 and 1050 draw toward each other, applying heat and pressure to each layer of the folded portion 415 at the weld area 1210. The separator 1305 prevents welding between layers 820 and 825. The result of the weld operation will thus be two 4-layered welds. A first 4-layered weld includes layers 805, 810, 815, and 820; a second 4-layered weld includes layers 825, 830, 835, and 840.

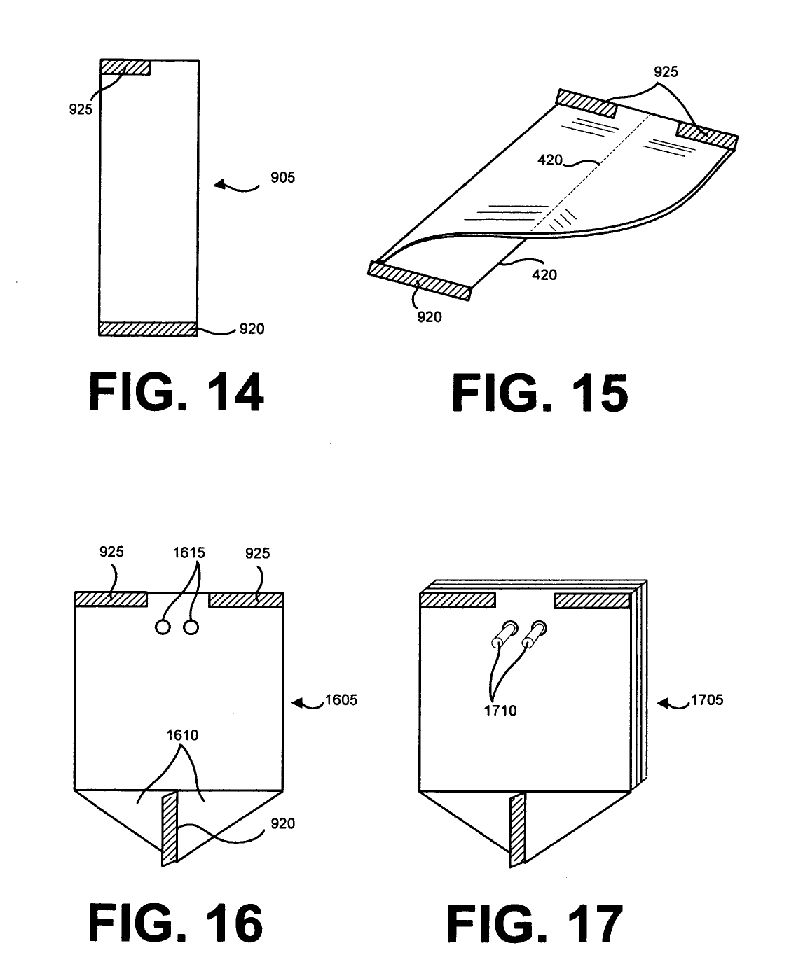

The lack of a weld between layers 820 and 825 facilitates the unfolding step 145, which is further described with reference to FIGS. 14-16 below.

FIG. 14 is a plan view of a folded bag portion, according to an embodiment of the invention. FIG. 15 is a perspective view of a partially-unfolded bag, according to an embodiment of the invention. FIG. 16 is a plan view of an unfolded and uncut bag, according to an embodiment of the invention.

FIGS. 14, 15, and 16 illustrate structures that may be associated with the unfolding step 145. Unfolding step 145 may receive an unfolded bag 905 and produce a partially unfolded bag as illustrated in FIG. 15 (e.g., in separating step 310). Unfolding step 145 would not be possible if layers 820 and 825 were welded to each other at the top weld 925. Unfolding step 145 also may include flattening the partially unfolded bag to produce the unfolded and uncut bag 1605 illustrated in FIG. 16 (e.g., in flattening step 315). The unfolded and uncut bag 1605 may thus include a flattened portion 1610.

The unfolded and uncut bag 1605 may further include stacking alignment holes 1615. The stacking alignment holes 1615 may be added before or during the stacking step 150. For instance, in one embodiment, there is a punching step in the 8-layer structure before the unfolding step 145. In this case, a single punch that is offset from the center line 420 will define the two stacking alignment holes 1615 when the folded bag is later unfolded. In an alternative embodiment, there is a punching step after the unfolding step 145 and before the stacking step 150 to form the stacking alignment holes 1645. In yet another embodiment, the alignment holes 1615 are formed during the stacking step 150, for example when a wicketer places an unfolded and uncut bag onto a stack of bags.

FIG. 17 is a perspective view of a pack of unfolded and uncut bags 1705, according to an embodiment of the invention. FIG. 17 illustrates the result of stacking step 150. The stacking alignment pins 1710 are configured to cooperate with the stacking alignment holes 1615. In an embodiment where the stacking alignment holes 1615 are formed during the stacking step 150, each of the stacking alignment pins 1710 may include a pointed tip that is configured to puncture a stacking alignment hole 1615 into each unfolded and uncut bag 1605 as it is added to the pack of unfolded and uncut bags 1705. The pack of unfolded and uncut bags 1705 may include any predetermined number of unfolded and uncut bags 1605. For instance, there may be 50 unfolded and uncut bags 1605 in each pack of unfolded and uncut bags 1705.

FIG. 18 is a perspective view of a bag-forming apparatus, according to an embodiment of the invention. The illustrated apparatus may be used to perform the unfolding and stacking steps 145 and 150, respectively.

As shown in FIG. 18, the apparatus may include an incoming conveyer 1810 that is configured to carry a folded bag 1805 in a first direction 1815. The apparatus may further include a conveyer 1825 that is configured to carry a folded bag 1820 in a second direction 1830. The conveyors 1810 and/or 1825 may utilize vacuum and/or static electricity to secure bags during processing and transport. A vacuum roller 1835 is configured to at least partially unfold the incoming folded bag 1820. In operation, the top four layers 1837 of an incoming folded bag are drawn to the vacuum roller 1835 while the bottom four layers (not shown) of the incoming folded bag remain secured to the conveyor 1825. As the conveyor 1825 advances the bag, the roller 1840 guides the top four layers 1837 to the conveyor 1825 to produce the unfolded bag 1845. In the illustrated embodiment, the roller 1840 has a smaller diameter than the vacuum roller 1835. One or more rollers 1850 flatten the unfolded bag 1845 to form the unfolded and uncut bag 1855. As shown, the rollers 1850 may be disposed on both a top side and a bottom side of a bag during flattening. The unfolded and uncut bag 1855 may have the same or similar configuration that is illustrated in FIG. 16.

The apparatus illustrated in FIG. 18 includes a wicketer 1860. The wicketer 1860 may include four wicket arms 1865. Each of the four wicket arms 1865 may include two end effectors 1880. Each of the end effectors may include vacuum holes to secure the unfolded and uncut bags during stacking step 150. The wicketer 1860 is configured such that the wicket arms rotate in a rotational direction 1870 about a rotational axis 1875. In operation, the wicketer 1865 transports an unfolded and uncut bag such that it progresses through the positions illustrated by uncut and unfolded bags 1855, 1885, and 1890. At the output side of the wicketer 1860, a stack of bags is formed on top of the unfolded and uncut bag 1890 with the aid of the alignment pins 1710 and the gripper 1894. Once a predetermined number of unfolded and uncut bags have been formed into a stack at the location of the bag 1890, a completed pack of unfolded and uncut bags may be output in the third direction 1896 on conveyor 1898.

Variations to the apparatus illustrated in FIG. 18 are possible. For example, the configuration of the conveyors 1810, 1825, and 1898 may be altered, according to design choice. In embodiments of the invention, the rotational speed of the vacuum roller 1835 may be intentionally mismatched with respect to the linear speed of the conveyor 1825. In addition, the relative size of the vacuum roller 1835 and the roller 1840 could be varied. More or fewer flattening rollers 1850 may be used. Also, alternative wicketers 1860 may include fewer or more than four wicketer arms 1865. In an alternative embodiment, a stacking module other than a wicketer 1860 could be used to form a stack of unfolded and uncut bags.

Functional components described elsewhere could be operationally coupled to the bag unfolding and stacking apparatus illustrated in FIG. 18. For instance, in embodiments of the invention, a cutting/welding module (not shown) that includes the die set 1005 could be coupled to the conveyor 1810. Moreover, a stacking alignment hole punching module (not shown) may interface with the conveyors 1810 or 1825, the stacking alignment hole punching module being configured to form the stacking alignment holes 1615 that are discussed above with reference to FIGS. 1 and 16. Consistent with the description above, the stacking alignment hole punching module could alternatively be disposed, for example, before or after the vacuum roller 1835, or even after the flattening rollers 1850. Furthermore, a bag pack punching/staking module (not shown), or, alternatively, a bag pack punching/pinning module (not shown), may be operationally coupled to the conveyor 1898 to perform punching/staking step 155 or a variation thereof.

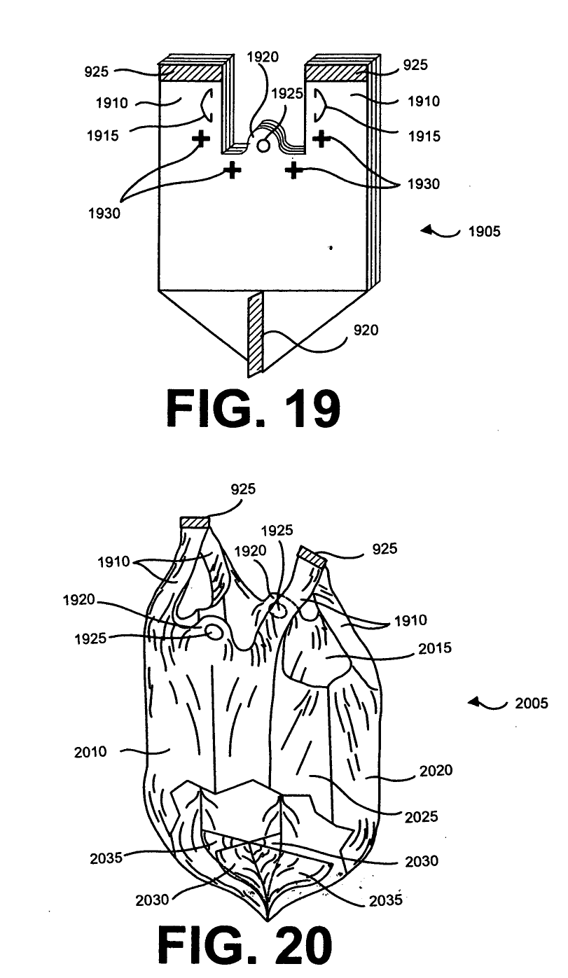

FIG. 19 is a perspective view of a bag pack, according to an embodiment of the invention. A bag pack 1905 may be output from the punching and staking step 155, or a variation thereof. As illustrated in FIG. 19, the bag pack 1905 may include handles 1910, and each of the handles 1910 may include a slit 1915 that is configured to suspend the t-shirt style bag pack 1905 from a rod or other hanging feature of a dispensing rack (not shown). Each of the bags in bag pack 1905 may further include a center tab 1920 having an aperture 1925 to also facilitate the suspension of the bag pack 1905 from the dispensing rack. The bag pack 1905 may also include one or more pinning points 1930 to lightly couple adjacent layers and bags in the bag pack 1905.

Alternatives to the configuration illustrated in FIG. 19 are possible. For example, the shape of the mouth formed between the handles 1910 may be varied, according to design choice. In addition, the quantity and shape of the aperture 1925 in each of the bags of the bag pack 1905 may be varied according to application needs. Moreover, there could be more than a single center tab 1920 in each of the bags. Further, the center tab 1920 could include one or more frangible features that are configured to fail when a bag is dispensed from the bag stack 1905 such that the center tab 1920 is retained with the bag rather than the dispensing rack. Staking points that have rounded geometries could be used together with, or instead of, the pinning points 1930 to provide releasable bonding between layers and bags within the bag pack 1905.

FIG. 20 is a perspective view of an opened bag, according to an embodiment of the invention. A bag 2005 may be one of many bags from a bag pack 1905. As shown therein, a bag 2005 may include a front side 2010, a back side 2015, and gusseted sides. For example, a right side of the bag 2005 includes gusseted sides 2020 and 2025.

Each of the handles 1910 include 4 layers that are joined at the top seal 925. For example, a front portion of the right handle 1910 includes an extension of the front layer 2010 and an extension of the gusseted side 2025; a rear portion of the right handle 1910 includes an extension of the rear layer 2015 and an extension of the gusseted side 2020.

As shown in a cutaway section, an inside bottom portion of the bag 2005 includes ribs 2030 and 2035. Each of the ribs 2030 and 2035 may be substantially triangular in shape. The ribs 2030 and 2035 intersect each other substantially at right angles.

Bag 2005 could also include slits 1915 and/or pinning points 1930. Moreover, one or more of the alternative configurations described above with reference to FIG. 19 may also apply to the bag 2005 that is illustrated in FIG. 20.

It will be apparent to those skilled in the art that modifications and variations can be made without deviating from the spirit or scope of the invention. For example, alternative features described herein could be combined in ways not explicitly illustrated or disclosed. Thus, it is intended that the present invention cover any such modifications and variations of this invention provided they come within the scope of the appended claims and their equivalents.

I claim:

1. A bag manufacturing system comprising:
a conveyor system; and
an unfolding module operationally coupled to the conveyor system, the unfolding module configured to at least partially unfold a folded bag to produce an unfolded bag, the folded bag having 8 layers, the unfolded bag having 4 layers.

2. The bag manufacturing system of claim 1, wherein the unfolding module includes:
a vacuum roller configured to at least partially unfold the folded bag to produce the unfolded bag; and
at least one flattening roller operationally coupled to the vacuum roller and configured to flatten the unfolded bag.

3. The bag manufacturing system of claim 1, further comprising a cutting/welding module operationally coupled to the conveyor system and configured to operate on the folded bag, the cutting/welding module including a die set.

4. The bag manufacturing system of claim 3, wherein the die set includes:
an upper die having a first heater tip, a second heater tip, and a blade; and
a lower die having a third heater tip, a fourth heater tip, and a plate;
the first heater tip and the third heater tip configured to cooperate in a first contact weld operation, the second heater tip and the fourth heater tip configured to cooperate in a second contact weld operation, the blade and the plate configured to cooperate in a cutting operation;
the die set being configured such that the first contact weld operation, the second contact weld operation, and the cutting operation can be performed substantially simultaneously.

5. The bag manufacturing system of claim 4, wherein the die set includes a separator, the separator operationally coupled to the first heater tip and the third heater tip, the separator configured such that it can be disposed between a fourth layer and a fifth layer of the folded bag during the first contact weld operation.

6. The bag manufacturing system of claim 5, wherein the separator is a metallic component having an anti-stick coating.

7. The bag manufacturing system of claim 6, wherein the separator is Teflon-coated steel.

8. The bag manufacturing system of claim 1, further comprising a bag stacking module operationally coupled to the conveyor system and configured to stack the unfolded bag onto another unfolded bag to form an uncut bag stack.

9. The bag manufacturing system of claim 8, wherein the bag stacking module includes a wicketer having at least one wicketer arm, the at least one wicketer arm having at least two end effectors, each of the two end effectors having at least one vacuum hole configured to secure the unfolded bag.

10. The bag manufacturing system of claim 9, wherein the wicketer includes four wicketer arms and each of the wicketer arms includes two end effectors.

11. The bag manufacturing system of claim 8, wherein the bag stacking module includes at least one stacking alignment pin configured to align the unfolded bag with the other unfolded bag during a bag stacking operation.

12. The bag manufacturing system of claim 11, further comprising a stacking alignment hole punching module operationally coupled to the conveyor system and configured to form at least one stacking alignment hole in the folded bag, the at least one stacking alignment hole configured to cooperate with the at least one stacking alignment pin.

13. The bag manufacturing system of claim 11, further comprising a stacking alignment hole punching module operationally coupled to the conveyor system and configured to form at least one stacking alignment hole in the unfolded bag, the at least one stacking alignment hole configured to cooperate with the at least one stacking alignment pin.

14. The bag manufacturing system of claim 8, further comprising a punching/staking module operationally coupled to the conveyor system and configured to punch at least one of a handle, a center tab, and a hanging aperture in the uncut bag stack to produce a bag stack, the punching/staking module further configured to form a releasable bond amongst all layers in the bag stack.

15. The bag manufacturing system of claim 8, further comprising a punching/pinning module operationally coupled to the conveyor system and configured to punch at least one of a handle, a center tab, and a hanging aperture in the uncut bag stack to produce a bag pack, the punching/pinning module further configured to form a releasable bond amongst all layers in the bag pack.

16. A bag manufacturing die set comprising:
an upper die having a first heater tip, a second heater tip, and a blade; and
a lower die having a third heater tip, a fourth heater tip, and a plate;
the first heater tip and the third heater tip configured to cooperate in a first contact weld operation, the second heater tip and the fourth heater tip configured to cooperate in a second contact weld operation, the blade and the plate configured to perform a cutting operation;
the die set being configured such that the first contact weld operation, the second contact weld operation, and the cutting operation can be performed substantially simultaneously;
the die set further including a separator, the separator operationally coupled to the first heater tip and the third heater tip, the separator configured such that it can be disposed between a fourth layer and a fifth layer of an 8-layer folded bag during the first contact weld operation.

17. The bag manufacturing die set of claim 16, wherein the separator is a metallic component having an anti-stick coating.

18. The bag manufacturing die set of claim 17, wherein the separator is Teflon-coated steel.
